(19) United States
(12) Patent Application Publication
(10) Pub. No.: US 2009/0236039 A1
(43) Pub. Date: Sep. 24, 2009

(54) ADHESION ASSEMBLY METHOD AND APPARATUS OF ARTICLE

(75) Inventors: Chikara TANAKA, Hiroshima-city (JP); Katsuya HIMURO, Hiroshima-city (JP)

Correspondence Address: Studebaker & Brackett PC, 1890 Preston White Drive, Suite 105, Reston, VA, 20191, US

(73) Assignee: MAZDA MOTOR CORPORATION, Aki-gun (JP)

(21) Appl. No.: 12/350,440

(22) Filed: Jan. 8, 2009

(30) Foreign Application Priority Data
Mar. 21, 2008 (JP) 2008-073599

(51) Int. Cl. B32B 37/02

(52) U.S. Cl. 156/292

(57) ABSTRACT

A heat energy as a second trigger energy is applied to an overlap portions in such a manner that a terminal portion of a first chain-reacting cure area which is presumed to be generated by applying the heat energy as a first trigger energy to an vehicle-body assembly member overlaps a start portion of a second chain-reacting cure area which is to be generated by applying the heat energy as the second trigger energy to the adhesive agent between the vehicle-body assembly member and the vehicle-body member. Accordingly, the adhesive agent can be made cure surely.

### BACKGROUND OF THE INVENTION

The present invention relates to an adhesion assembly method and apparatus of an article, in which a plurality of members are joined with an adhesive agent having a chain-reacting curing reaction function that is disposed at joining portions of the members, thereby assembling the article.

In these days, an adhesion joining using an adhesive agent, in addition to a welding technology such as a spot welding or laser welding, has been used as joining means for efficiently increasing the rigidity of vehicle-body members to make the vehicle body lighter in an automobile assembling technology. For example, a weld-bond method using both the adhesive agent and the spot welding has been actually used to join the vehicle-body members at joining portions of their flanges which are formed at end portions of the members.

In this weld-bond method, the adhesive agent is applied to the joining portion of one of the vehicle-body members, a joining portion of another vehicle-body member is disposed so at to overlap the joining portion of the above-described one of the members, a temporary joining is provided by the spot welding applied to their joining portions with a pair of welding electrodes, then the adhesive agent is made cure in a paint-drying device. Herein, it may take some time for the adhesive agent to cure, so some additional assist means for temporally fixing, such as the spot welding, or fixing with rivets, may be necessary. This may require moving the guns of spot welding or the heads of striking rivets, so that the manufacturing time and costs would increase improperly.

In the meantime, there exists a quick-curing adhesive agent which cures quickly with application of a light or heat energy, such as ultraviolet rays or infrared rays. An ultraviolet-curing adhesive agent or an adhesive agent made from cyanoacrylate is known as a quick-curing adhesive agent. Recently, an adhesive agent having a chain-reacting curing reaction function is also known, which is disclosed in U.S. Pat. No. 6,599,954, for example. In this adhesive agent having the chain-reacting curing reaction function, when some energy as a trigger energy is applied to this adhesive agent from outside, a heat energy of curing reaction is positively generated within the adhesive agent, and the curing reaction is further effected, like a chain reaction, by the heat energy of curing reaction to successively generate an additional heat energy of curing reaction, so that the adhesive agent can cure by means of these reaction heat energies.

Herein, the above-described adhesion joining with the ultraviolet-curing adhesive agent and the adhesive agent made from cyanoacrylate have respective problems in that a specified portion that is not exposed to ultraviolet rays may not cure and a tack time may be too short. Meanwhile, it may be important to ensure a stable, successive generation of the curing reaction heat for the above-described adhesive agent having the chain-reacting curing reaction function. For example, if the continuous application of the adhesive agent to the joining portion of the member was prevented due to the plugged nozzle for applying the adhesive agent or the reaction heat was let go away to an outside portion due to cooling by a clamp member or the like, there may occur a problem in that the curing-chain reaction of the adhesive agent would stop improperly.

In this case, since the adhesive agent could not cure properly to a terminal portion of a chain-reacting cure area, part of the adhesive agent around the terminal portion of the chain-reacting cure area would remain in a non-cure state. As a result, there may occur a problem in that the sufficient joining strength could not be obtained and thereby the joining portions would improperly separate from each other.

### SUMMARY OF THE INVENTION

An object of the present invention is to provide an adhesion assembly method and apparatus of an article which can make the adhesive agent having the chain-reacting curing reaction function cure surely.

According to a first aspect of the present invention, there is provided an adhesion assembly method of an article, in which a plurality of members are joined with an adhesive agent having a chain-reacting curing reaction function that is disposed at joining portions of the members, thereby assembling the article, comprising a first adhesive-agent disposition step of disposing the adhesive agent at a joining portion of at least one of the members, a first trigger-application cure step of curing the adhesive agent disposed at the joining portion of at least one of the members by applying a first trigger energy for causing a chain-reacting curing reaction of the adhesive agent at a first specified point of the adhesive agent in a state in which a joining portion of another member overlaps the joining portion of the member at which the adhesive agent is disposed, thereby joining a pair of members, a second adhesive-agent disposition step of disposing the adhesive agent at a joining portion of a different member which is to be joined to the pair of members and/or a joining portion of the pair of members which is to be joined to the joining portion of the different member, and a second trigger-application cure step of curing the adhesive agent disposed at the joining portion of the different member and/or the joining portion of the pair of members by applying a second trigger energy for causing a chain-reacting curing reaction of the adhesive agent at a second specified point of the adhesive agent, thereby joining the different member to the pair of members, wherein the second specified point of the adhesive agent where the second trigger energy is applied is configured such that a terminal portion of a first chain-reacting cure area of the adhesive agent which is presumed to be generated by applying the first trigger energy to the adhesive agent of the pair of members overlaps a start portion of a second chain-reacting cure area of the adhesive agent which is to be generated by applying the second trigger energy to the adhesive agent between the pair of members and the different member.

According to the adhesion assembly method of an article of the first aspect of the present invention, the adhesive agent having the chain-reacting curing reaction function is disposed at the joining portion of at least one of the members, and the energy as the first trigger energy is applied to the first specified point of the adhesive agent in the state in which the joining portion of another member overlaps the joining portion of the above-described member. Thereby, the heat energy of curing reaction is positively generated within the adhesive agent around the first specified point where the first trigger energy is applied, and this reaction heat energy further causes the curing reaction of part of the adhesive agent which is adjacent to this adhesive agent around the first specified point where the first trigger energy is applied, so that the curing reaction occurs in the adhesive agent like the chain reaction. Thus, the pair of members is joined at their joining portions.

Then, the adhesive agent is disposed at the joining portion of the different member which is to be joined to the pair of members and/or the joining portion of the pair of members which is to be joined to the joining portion of the different member, and the second trigger energy is applied to the second specified point of the adhesive agent, which is configured such that the terminal portion of the first chain-reacting cure area of the adhesive agent overlaps the start portion of the second chain-reacting cure area of the adhesive agent which is to be generated by applying the second trigger energy to the adhesive agent between the pair of members and the different member. Thereby, the curing reaction occurs in the adhesive agent at the second chain-reacting cure area of the adhesive agent as well like the chain reaction. Further, even if there exits part of the adhesive agent which remains in the non-cure state in the first chain-reacting cure area, this part of the adhesive agent of the first chain-reacting cure area can be surely made cure with the chain curing reaction from the terminal portion of the first chain-reacting cure area which is caused by the second trigger energy applied. Thus, both the adhesive agent disposed at the pair of members and the adhesive agent disposed between the pair of members and the different member can be made cure surely. Accordingly, the proper joining of the pair of the members and the different member can be provided.

According to an embodiment of the first aspect of the present invention, the first chain-reacting cure area comprises plural areas which are disposed linearly on the joining portion of the member, and the first specified point of the adhesive agent where the first trigger energy is applied is located substantially at a central portion of the first chain-reacting cure area. Thereby, the chain-reacting curing reaction of the first chain-reacting cure area can be made occur quickly and stably.

According to another embodiment of the first aspect of the present invention, the second specified point of the adhesive agent where the second trigger energy is applied is located substantially at the terminal portion at both ends of the first chain-reacting cure area. Thereby, the performance of the present invention can be provided surely.

According to another embodiment of the first aspect of the present invention, the applying the first or second trigger energy is applying a heat energy. Thereby, the trigger energy to cause the chain-reacting curing reaction of the adhesive agents in the first and second chain-reacting cure areas can be applied with a properly simple means.

According to a second aspect of the present invention, there is provided an adhesion assembly apparatus of an article, in which a plurality of members are joined with an adhesive agent having a chain-reacting curing reaction function that is disposed at joining portions of the members, thereby assembling the article, comprising a first trigger application means for applying a first trigger energy for causing a chain-reacting curing reaction of the adhesive agent, which is disposed at a joining portion of at least one of the members, at a first specified point of the adhesive agent in a state in which a joining portion of another member overlaps the joining portion of the member at which the adhesive agent is disposed, and a second trigger application means for applying a second trigger energy for causing a chain-reacting curing reaction of the adhesive agent, which is disposed at a joining portion of a different member which is to be joined to the pair of members and/or a joining portion of the pair of members which is to be joined to the joining portion of the different member, at a second specified point of the adhesive agent, wherein the second specified point of the adhesive agent where the second trigger energy is applied is configured such that a terminal portion of a first chain-reacting cure area of the adhesive agent which is presumed to be generated by applying the first trigger energy to the adhesive agent of the pair of members overlaps a start portion of a second chain-reacting cure area of the adhesive agent which is to be generated by applying the second trigger energy to the adhesive agent between the pair of members and the different member. According the second aspect of the present invention, substantially the same performance as the above-described first aspect of the present invention can be provided.

According to an embodiment of the second aspect of the present invention, the first chain-reacting cure area comprises plural areas which are disposed linearly on the joining portion of the member, and the first specified point of the adhesive agent where the first trigger energy is applied by the first trigger application means is located substantially at a central portion of the first chain-reacting cure area. Thereby, substantially the same advantages as the above-described embodiment of the first aspect of the present invention can be provided.

According to another embodiment of the second aspect of the present invention, the second specified point of the adhesive agent where the second trigger energy is applied by the second trigger application means is located substantially at said terminal portion at both ends of said first chain-reacting cure area. Thereby, substantially the same advantages as the above-described another embodiment of first aspect of the present invention can be provided.

According to another embodiment of the second aspect of the present invention, the first and second trigger application means are configured to apply the heat energy as the trigger energy. Thereby, substantially the same advantages as the above-described another embodiment of the first aspect of the present invention can be provided.

Other features, aspects, and advantages of the present invention will become apparent from the following description which refers to the accompanying drawings.

### BRIEF DESCRIPTION OF THE DRAWINGS

FIG. 1 is a plan view of part of a vehicle-body member adhesion assembly line of an automotive vehicle.

FIG. 2 is a plan view of the rest of the vehicle-body member adhesion assembly line.

FIG. 3 is a perspective view showing a state of vehicle-body members which is before making them overlap each other.

FIG. 4 is a perspective view showing a state of the vehicle-body members which are joined at both joining portions with an adhesive agent and a first chain-reacting cure area.

FIG. 5 is a perspective view showing a state of a vehicle-body assembly member and a vehicle-body member which is before making them overlap each other and a second chain-reacting cure area of the vehicle body member.

FIG. 6 is a perspective view showing a state of the vehicle-body assembly member and the vehicle-body member which are joined at both joining portions with an adhesive agent.

FIG. 7 is an explanatory diagram showing a state in which a first trigger energy is applied to the joining portion of the vehicle-body member.

FIG. 8 is an explanatory diagram according to a modified embodiment, which corresponds to FIG. 7.

FIG. 9 is an explanatory diagram according to another modified embodiment, which corresponds to FIG. 7.

### DETAILED DESCRIPTION OF THE INVENTION

Hereinafter, preferred embodiments of the present invention will be described. The embodiments show an example in which an adhesion assembly method and apparatus of an article, in which a plurality of members are joined with an adhesive agent that is disposed at joining portions of the members, thereby assembling the article, is adopted to a vehicle-body member adhesion assembly line.

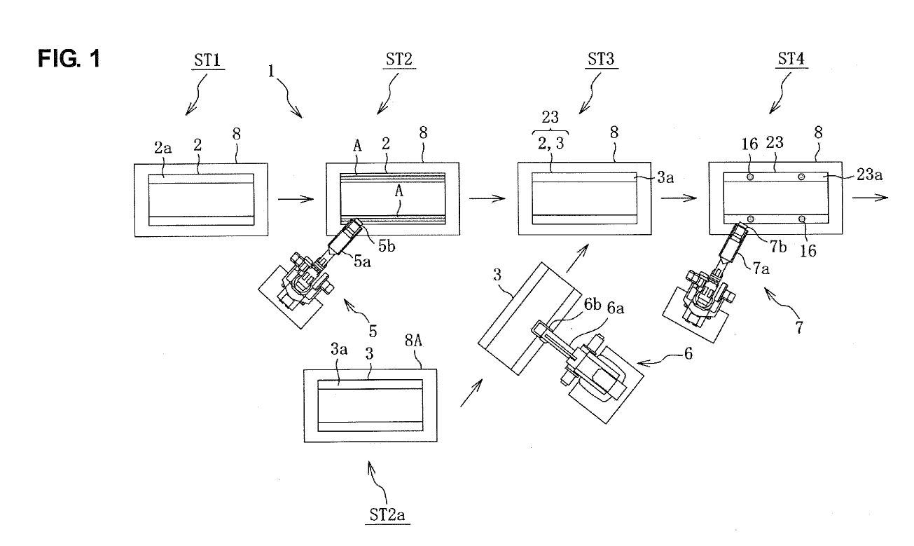

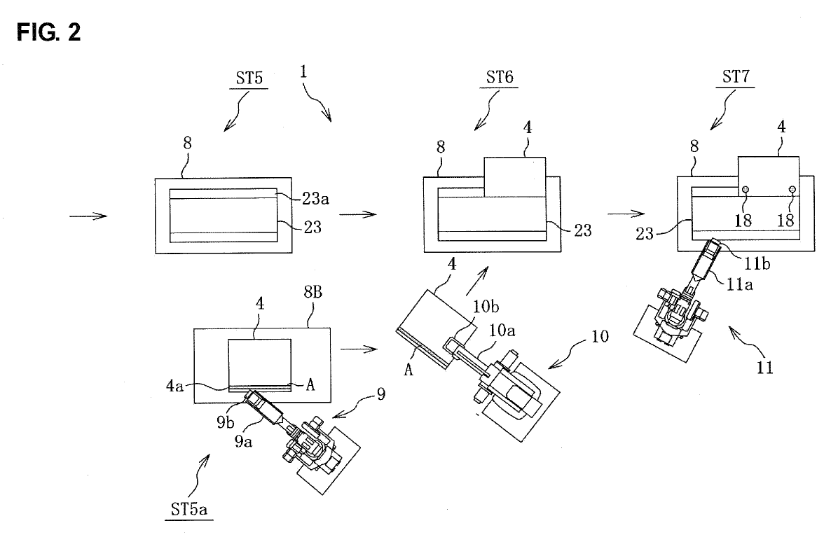

Hereinafter, an embodiment of the present invention will be described referring to the accompanying figures. As shown in FIGS. 1 and 2, in a vehicle-body member adhesion assembly line 1 of an automotive vehicle, a pair of vehicle-body members 2, 3 is joined with an adhesive agent A that is disposed at joining portions of the members 2, 3, thereby assembling a vehicle-body assembly member 23. Further, a joining portion 4a of another vehicle-body member 4 which is different from the members 2, 3 is joined to a joining portion 23a of the vehicle-body assembly member 23 with the adhesive agent A.

As shown in FIGS. 1 and 2, the vehicle-body member adhesion assembly line 1 is an assembly line to assemble various vehicle-body members which are put into pallets 8 on a conveyer. Reference character STi (i=1, 2 . . . ) denotes each assembly station. The vehicle-body members 2, 3 to be assembled in the adhesion assembly line 1 are a front frame inner and a front frame outer of a front frame of the automotive vehicle which is made of steel. The vehicle-body assembly member 23 which is made of the joined vehicle-body members 2, 3 is a front frame having a closed cross section. A vehicle-body member 4 is a wheel apron, which is made of steel, to be joined to the front frame.

Reference character ST1 denotes a station for putting the vehicle-body member 2 into the pallet 8, reference character ST2 denotes a station for applying the adhesive agent A having a chain-reacting curing reaction function, which will be described in detail below, to a joining portion 2a (flange portion) of the vehicle-body member 2 with an adhesive-agent application robot 5, reference character ST2a denotes a station for clamping the vehicle-body member 3 with a member carrying robot 6 to carry it from a self-moving truck 8A, reference character ST3 denotes a station for assembling the vehicle-body member 3 to the vehicle-body member 2 on the pallet 8 with the member carrying robot 6, and reference character ST4 denotes a station for applying a heat energy as a first trigger energy to the joining portion 23a of the vehicle-body assembly member 23 with a first-trigger application robot 7 at plural points.

Reference character ST5 denotes a cure station for curing the adhesive agent A at the joining portion 23a of the vehicle-body assembly member 23, reference character ST5a denotes an adhesive-agent application station for applying the adhesive agent A having the chain-reacting curing reaction function, which will be described below, to the joining portion 4a of the vehicle-body member 4 on a truck 8B with an adhesive-agent application robot 9, reference character ST6 denotes a station for assembling the vehicle-body member 4 to the vehicle-body assembly member 23 with the closed cross section which is made of the joined vehicle-body members 2, 3 with a member carrying robot 10, and reference character ST7 denotes a station for applying the heat energy as the second trigger energy to the joining portion 23a of the vehicle-body assembly member 23 and the joining portion 4a of the vehicle-body member 4 with a second-trigger application robot 11 at plural points.

The adhesive-agent application robot 5, which is a general multi-joint type of robot, is disposed at the station ST2. An adhesive-agent application nozzle 5b is attached to a hand at the tip of an arm 5a of the robot 5. The adhesive-agent application nozzle 5b is coupled to an adhesive-agent supply apparatus (not illustrated) to receive the pressurized adhesive agent A from the adhesive-agent supply apparatus, and applies the adhesive agent A to a pair of joining portions 2a of the vehicle-body member 2. A control unit of the adhesive-agent application robot 5, the adhesive-agent supply apparatus and the adhesive-agent application nozzle 5b are controlled by a host controller (not illustrated).

The multi-joint type of carrying robot 6 is disposed between the stations ST2a and ST3. The carrying robot 6 clamps the vehicle-body member 3 on the truck 8A with a clamping jig 6b attached to a hand at the tip of its arm 6a, and carries and assembles it to the vehicle-body member 2 on the pallet 8 at the station ST3 in a state in which the joining portions 2a, 3a of the vehicle-body members 2, 3 contact each other. A control unit of the carrying robot 6 and the clamping jig 6b are controlled by the host controller (not illustrated).

The member carrying robot 6 is configured to move between its clamping position for clamping the vehicle-body member 3 held on the truck 8A with the clamping jig 6b and its releasing position for releasing the clamping of the vehicle-body member 3 after carrying the member 3 to the station ST3 and then assembling it to the vehicle-body member 2 on the pallet 8.

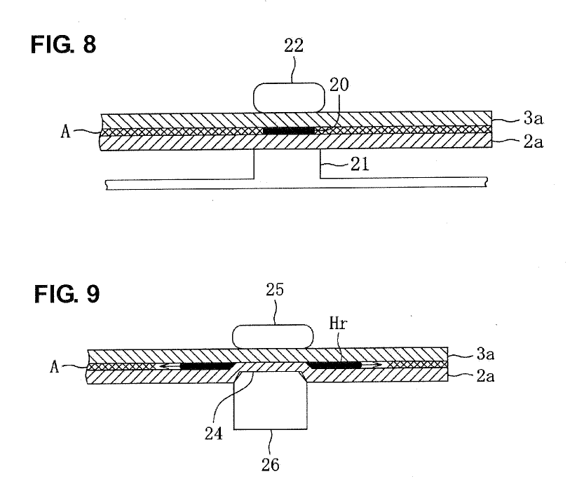

The first-trigger application robot 7, which is the general multi-joint type of robot, is provided at the station ST4. The robot 7 applies the heat energy as the first trigger energy to the joining portions 2a, 3a of the vehicle-body members 2, 3 at plural points and thereby makes the adhesive agent A cure. This robot 7 is configured to apply the heat energy H (the heat of 100 degrees or higher, for example) (see FIG. 8) as the trigger energy to cause the chain-reacting curing reaction of the adhesive agent A disposed between the joining portions 2a, 3a of the vehicle-body members 2, 3.

A spot type of energy emitting portion 7b, which may comprise an electric heater or the like, is provided at a hand at the tip of an arm 7a of the first-trigger application robot 7. This robot 7 is configured to move between its energy application position for applying the heart energy H to the joining portions 2a, 3a of the vehicle-body members 2, 3 held on the pallet 8 with the energy emitting portion 7b and its standby position which retreats from the energy application position. A control unit of the robot 7, the electric heater and the energy emitting portion 7b are controlled by the host controller (not illustrated).

As shown in FIG. 2, an adhesive-agent application robot 9, which is similar to the adhesive-agent application robot 5, is disposed at the station ST5a. An adhesive-agent application nozzle 9b is attached to a hand at the tip of an arm 9a of the robot 9. The adhesive-agent application nozzle 9b receives the adhesive agent A from the adhesive-agent supply apparatus (not illustrated). A control unit of the adhesive-agent application robot 9, the adhesive-agent supply apparatus and the adhesive-agent application nozzle 9b are controlled by the host controller (not illustrated).

Between the stations ST5a and ST6 is disposed a carrying robot 10 which is similar to the carrying robot 6. This robot 10 clamps the vehicle-body member 4 on the truck 8B with a clamping jig 10b attached to a hand at the tip of its arm la, caries it to the station ST6 and assembles it to the vehicle-body assembly member 23 of the joined vehicle-body members 2, 3 on the pallet 8 in a state in which the respective joining portions 23a, 4a of the vehicle-body assembly member 23 and the vehicle-body member 4 contact each other. Herein, the adhesive agent A of the joining portion 4a is located between the joining portions 23a, 4a.

A second-trigger application robot 11, which is similar to the first-trigger application robot 7, is provided at the station ST7. This robot 11 has a spot type of energy emitting portion 11b, which may comprise an electric heater or the like, at a hand at the tip of its arm 11a. The robot 11 applies the heat energy H as the second trigger energy to the joining portions 23a, 4a of the vehicle-body assembly member 23 and the vehicle-body member 4 with the adhesive agent A disposed between the joining portions 23a, 4a.

Hereinafter, the adhesion assembly method of an article which assembles a vehicle-body block by joining the joining portions 2a, 3a, 4a of the plural vehicle-body members 2, 3, 4 with the adhesive agent A in the above-described adhesion assembly line 1 will be described in detail.

In a first adhesive-agent disposition step, as shown in FIG. 1, the adhesive agent A having the chain-reacting curing reaction function, which is a liquid type, is applied to the joining portion 2a (flange portion) of the end portion of the vehicle-body member 2 by the adhesive-agent application robot 5 with the adhesive-agent application nozzle 5b attached to its hand at the station ST2. The adhesive agent A having the chain-reacting curing reaction function is a resin composition that primarily comprises a photopolymerizable resin (mainly, epoxy resin, and preferably alicyclic epoxy resin), a photo- and thermopolymerization initiator (e.g., aromatic sulfonium salt), and a photopolymerization initiator (e.g., sulfonium salt).

Herein, when this adhesive agent is exposed to energy radiation, such as ultraviolet radiation, electron beam, X-rays, infrared radiation, sunlight, visible light, laser beam (e.g., excimer laser, CO₂ laser), radiated heat rays, and other energy such as heat, a cation and a heat of curing reaction Hr (see FIG. 7) are positively generated within the resin composition of the adhesive agent, so that the resin composition of the adhesive agent is cured by means of the reaction heat energies and the cation like a chain reaction. The application thickness of the adhesive agent A is preferably 0.01-10 mm, and the application width is preferably 1.0-30 mm. The curing conditions of the adhesive agent A are to radiate energy beams that can give an energy equivalent to a heat of 100 degrees centigrade or greater.

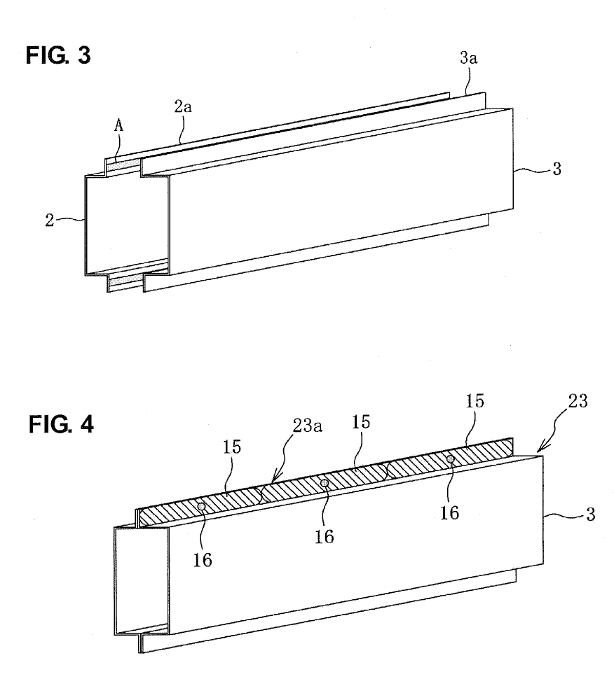

In the first adhesive-agent disposition step, as shown in FIGS. 3-5, the adhesive agent A is applied continuously and linearly along the longitudinal direction of the joining portion 2a of the vehicle-body member 2. This adhesive-agent application area is split into plural areas, and these split areas are configured to be chain-reacting cure areas of the adhesive agent A which are presumed to be generated by applying the heat energy H to the adhesive agent A. That is, by dividing the above-described adhesive-agent application area by a specified distance which corresponds to the chain-reacting-cure progress distance of the adhesive agent A or less (100 mm, for example), a plurality of first chain-reacting cure areas 15 are provided (see the areas having slant lines in FIG. 4).

Next, in a first member assembly step, at the steps ST2a and ST3, the vehicle-body member 3 is carried to the pallet 8 with the held vehicle-body member 2 by the member carrying robot 6 such that the joining portion 3a of the vehicle-body member 3 overlaps the joining portion 2a of the vehicle-body member 2 with the adhesive agent A applied as shown in FIG. 4.

Then, in a first trigger-application cure step, at the step ST4, the heat energy H as the first trigger energy is applied at plural points in a state in which the joining portions 2a, 3a are overlapped, by making the tip of the energy emitting portion 7b of the first-trigger application robot 7 contact the outer face of the joining portion 3a of the vehicle-body member 3.

Herein, a first trigger-application point 16 is set at the central portion of each first chain-reacting cure area 15 as shown in FIG. 4. As shown in FIG. 7, when the beat energy H is applied to the outer face of the joining portion 23a from the trigger-application point 16, it transmits to the adhesive agent A from the joining portion 23a, thereby generating the cation and the heat of curing reaction Hr at the first chain-reacting cure area 15 of the adhesive agent A. The heat of curing reaction Hr transmits in a direction of an arrow in FIG. 7, which causes the chain-reacting curing reaction. The heat energy is applied to the outer face of the joining portion 23a for a specified period of time with a properly high temperature enough to cure the adhesive agent A in accordance with the thickness and the tact of the joining portion 23a.

Once the chain-reacting curing reaction starts, the adhesive agent A adjacent to the part of the adhesive agent A where the curing reaction heat generates is made cure quickly and in the chain manner by the curing reaction heat Hr. This chain-reacting curing reaction progresses to the terminal portion of the first chain-reacting cure area 15. That is, the joining portions 2a, 3a of the vehicle-body members 2, 3 are joined quickly, so that the vehicle-body assembly member 23 with the closed cross section is formed.

Herein, if the continuous application of the adhesive agent A to the joining portion 2a was prevented due to the plugged adhesive-agent application nozzle 5b for applying the adhesive agent or the curing reaction heat Hr was let go away to an outside portion due to cooling by something, there may occur a problem in that the curing-chain reaction of the adhesive agent would stop improperly. As a result, part of the adhesive agent A after this stop area would not cure properly, remaining in the non-cure state.

Next, in a second adhesive-agent disposition step at the station ST5a shown in FIG. 2, the adhesive agent A having the chain-reacting curing reaction function is applied to the joining portion 4a of the vehicle-body member 4 on the truck 8B by the adhesive-agent application robot 9.

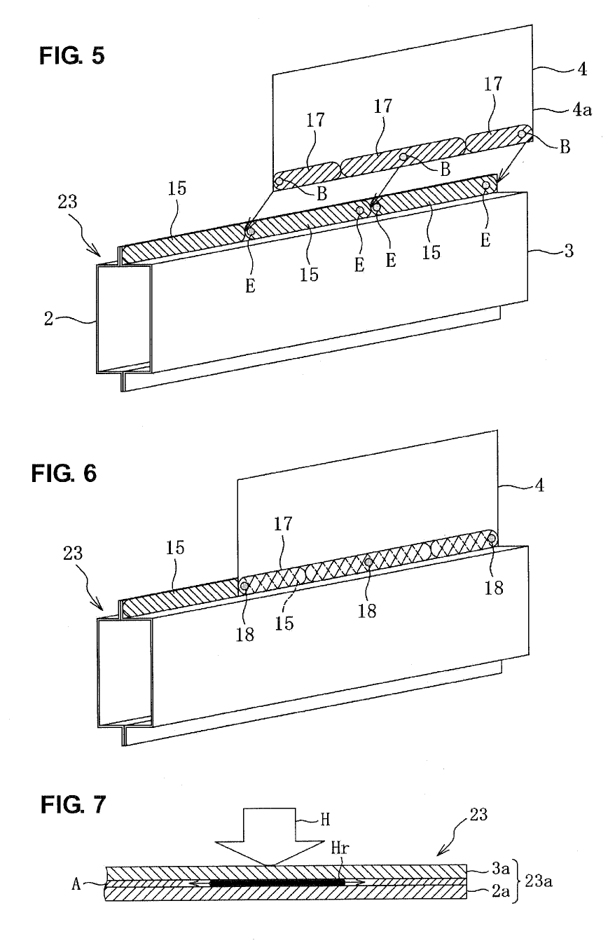

Then, as shown in FIG. 5, the adhesive agent A is applied continuously and linearly to the joining portion 4a of the vehicle-body member 4 which is to be joined to the joining portion 23a of the vehicle-body assembly member 23. This adhesive-agent application area is split into plural areas, and these split areas are configured to be chain-reacting cure areas of the adhesive agent A which are presumed to be generated by applying the heat energy H to the adhesive agent A. By dividing the above-described adhesive-agent application area by the specified distance which corresponds to the chain-reacting-cure progress distance of the adhesive agent A or less (100 mm, for example), a plurality of second chain-reacting cure areas 17 are provided (see the areas having slant lines in FIG. 5).

Next, when the vehicle-body assembly member 23 is carried to the station ST6, the member carrying robot 10 carries the vehicle-body member 4 to the vehicle-body assembly member 23 on the pallet 8 such that the joining portion 4a of the vehicle-body member 4 with the adhesive agent A applied overlaps the outer face (outside face in the vehicle width direction) of the joining portion 23a of the vehicle-body assembly member 23.

Herein, as shown in FIG. 5, the members are joined such that a terminal portion E of the first chain-reacting cure area 15 overlaps a start portion B of the second chain-reacting cure area 17. In the second trigger-application cure step, as shown in FIG. 6, the tip of the energy emitting portion 11b of the second-trigger application robot 11 is moved so as to contact an overlap portion 18 of the terminal portion E and the start portion B. Thus, the heat energy H as the second trigger energy is applied at plural points. That is, in other words, the heat energy H as the second trigger energy is applied in such a manner that the terminal portion E of the first chain-reacting cure area 15 of the adhesive agent A which is presumed to be generated by applying the heat energy H as the first trigger energy to the adhesive agent A of the vehicle-body assembly member 23 overlaps the start portion B of the second chain-reacting cure area 17 of the adhesive agent A which is to be generated by applying the heat energy H as the second trigger energy to the adhesive agent A between the vehicle-body assembly member 23 and the vehicle-body member 4.

When the heat energy H is applied to the above-described overlap portion 18, it transmits to the adhesive agent A from the vehicle-body member 4 and also to the joining portion 23a (joining portion which corresponds to the terminal portion E at the both sides of the first chain-reacting cure area 15) of the vehicle-body assembly member 23. The heat energy H is applied to the overlap portion 18 for a specified period of time with a properly high temperature enough to cure the adhesive agent A in accordance with the thickness and the tact of the overlap portion 18.

In the second chain-reacting cure area 17, the adhesive agent A is made cure by the heat energy H and thereby the cation and the curing reaction heat Hr are generated. The curing reaction heat Hr transmits to its adjacent part of the adhesive agent A and causes the chain-reacting curing reaction. Once this chain-reacting curing reaction starts, the adhesive agent A in the second chain-reacting cure area 17 is made cure quickly and in the chain manner by the curing reaction heat Hr.

Herein, the heat energy H as the second trigger energy also transmits to the terminal portion E of the first chain-reacting cure area 15 at the joining portion 23a of the vehicle-body assembly member 23 from the vehicle-body member 4. Accordingly, even if the part of the adhesive agent A in the non-cure state had existed at the terminal portion E or its adjacent portion of the first chain-reacting cure area 15, such part of the adjacent agent A receives the heat energy H from the vehicle-body member 4 which is applied from the energy emitting portion 11b of the second-trigger application robot 11 via the overlap portion 18, so that the chain-reacting curing reaction of the adhesive agent A occurs in the first chain-reacting cure area 15 including the above-described part of the adhesive agent A.

That is, applying the heat energy H as the second trigger energy to the overlap portion 18 can make the adhesive agent A in the non-cure state cure surely. As a result, the joining portions 2a, 3a of the vehicle-body members 2, 3 can be joined properly, and the joining portion 23a of the vehicle-body assembly member 23 and the joining portion 4a of the vehicle-body member 4 can be joined quickly, thereby assembling the article having the proper joining strength.

Next, the operation and advantages of the above-described joining assembly method and joining assembly line (corresponding to the joining assembly apparatus) of the article will be described. In case of assembling the vehicle-body assembly member 23 by joining the joining portions 2a, 3a of the vehicle-body members 2, 3 with the adhesive agent A having the chain-reacting curing reaction function, the heat energy H as the first trigger energy is applied to the joining portions 2a, 3a at the central portion of the first chain-reacting cure area 15 with the first trigger-application robot 7 in the state in which the joining portion 2a of the vehicle-body member 2 with the applied adhesive agent A overlaps the joining portion 3a of the vehicle-body member 3. The adhesive agent A is made cure by the heat energy H and thereby the cation and the curing reaction heat Hr are generated. The curing reaction heat Hr transmits to its adjacent part of the adhesive agent A and causes the chain-reacting curing reaction. Thus, the both joining portions 2a, 3a of the vehicle-body members 2, 3 can be joined quickly.

The adhesive agent A having the chain-reacting curing reaction function is applied to the joining portion 4a of the vehicle-body member 4, and the joining portion 23a of the vehicle-body assembly member 23 and the joining portion 4a of the vehicle-body member 4 are joined with the adhesion. Herein, the heat energy H as the second trigger energy is applied to the overlap portions 18 with the second trigger-application robot 7 in such a manner that the terminal portion E of the first chain-reacting cure area 15 of the adhesive agent A which is presumed to be generated by applying the heat energy H as the first trigger energy to the adhesive agent A of the vehicle-body assembly member 23 overlaps the start portion B of the second chain-reacting cure area 17 of the adhesive agent A which is to be generated by applying the heat energy H as the second trigger energy to the adhesive agent A between the vehicle-body assembly member 23 and the vehicle-body member 4. Accordingly, even if the part of the adhesive agent A in the non-cure state had existed at the terminal portion E or its adjacent portion of the joining portions 2a, 3a of the vehicle-body members 2, 3, such part of the adjacent agent A receives the heat energy H as the second trigger energy which has been applied for joining the joining portions 23a, 4a, so that the chain-reacting curing reaction of the adhesive agent A occurs in this part of the adhesive agent A, thereby making the adhesive agent A in the first chain-reacting cure area 15 cure surely.

The plural first chain-reacting cure areas 15 are disposed linearly on the joining portions 2a, 3a of the vehicle-body members 2, 3, the first trigger-application robot 7 applies the heat energy H as the first trigger energy at the central portion of the first chain-reacting cure area 15. Accordingly, the chain-reacting curing reaction of the first chain-reacting cure area 15 can be made occur quickly and stably.

Hereinafter, modified embodiments in which the above-described embodiment is partially modified will be described.

1) While the adhesive agent A having the chain-reacting curing reaction function is made cure by applying the heat energy H with the trigger-application robots 7, 11 in the above-described embodiment, a spacer 20 which is operative to control the thickness of the adhesive agent may be utilized as the trigger so that the adhesive agent A can be made cure by making the spacer generate the heat.

In this modified embodiment, as shown in FIG. 8, when the joining portion 2a of the vehicle-body member 2 with the applied adhesive agent A overlaps the joining portion 3a of the vehicle-body member 3, the above-described spacer 20, which is made of a metal bar or the like, is disposed between the joining portions 2a, 3a such that the both joining portions 2a, 3a are clamped with a positioning jig 21 and a damper 22. Herein, the damper 22 is configured to generate a heat, and the generated heat transmits to the space 20, thereby starts the cure of the adhesive agent A.

2) A positioning jig 26 may be utilized as the trigger so that the adhesive agent A can be made cure by making this positioning jig generate the heat. That is, as shown in FIG. 9, the joining portion 2a of the vehicle-body member 2 is pressed so as to form a projection portion 24, the vehicle-body member with the applied adhesive agent A and the joining portion 3a of the vehicle-body member 3 are clamped with a damper 25 and the positioning jig 26. Herein, the positioning jig 26 which is located at the projection portion 24 is configured to generate the heat, thereby generating the cation and the curing reaction heat Hr which causes the chain-reacting curing reaction of the adhesive agent A. Herein, the projection portion 24 may be formed by pressing the positioning jig 26 against the member.

3) While the adhesive agent A is applied to the joining portion 4a of the vehicle-body member 4 (different member) to be joined to the joining portion 23a of the vehicle-body assembly member 23 in the above-described embodiment, it may be applied to the joining portion 23a of the vehicle-body assembly member 23, then the joining portions 4a, 23a of the vehicle-body member 4 and the vehicle-body assembly member 23 may be disposed so as to overlap each other.

4) While the heat energy H is applied as the trigger energy in the above-described embodiment, a light energy (ultraviolet rays, laser beam, etc.) may be applied. In this case, a notch may be formed at the joining portion of the vehicle-body member, and the energy beam such as the ultraviolet rays may be directly applied to the adhesive agent A having the chain-reacting curing reaction function which is exposed through the notch, thereby making the adhesive agent A cure.

5) While the liquid type of adhesive agent A is used in the above-descried embodiment, the kind of adhesive agent and its disposition manner may be changed in accordance with the kind of article to be assembled. For example, a solid and sheet type of adhesive agent may be used for a sheet type of member.

6) The adhesion assembly technology of an article according to the present invention is applicable to any manufacturing line of not only an automotive vehicle but an aircraft, railway vehicle and the like. The application should not be limited to a particular filed.

7) Any other modifications and improvements may be applied in the scope of a sprit of the present invention.

What is claimed is:

1. An adhesion assembly method of an article, in which a plurality of members are joined with an adhesive agent having a chain-reacting curing reaction function that is disposed at joining portions of the members, thereby assembling the article, comprising:
a first adhesive-agent disposition step of disposing the adhesive agent at a joining portion of at least one of the members;
a first trigger-application cure step of curing said adhesive agent disposed at the joining portion of at least one of the members by applying a first trigger energy for causing a chain-reacting curing reaction of the adhesive agent at a first specified point of the adhesive agent in a state in which a joining portion of another member overlaps the joining portion of said member at which the adhesive agent is disposed, thereby joining a pair of members;
a second adhesive-agent disposition step of disposing the adhesive agent at a joining portion of a different member which is to be joined to said pair of members and/or a joining portion of said pair of members which is to be joined to the joining portion of the different member; and
a second trigger-application cure step of curing said adhesive agent disposed at the joining portion of said different member and/or the joining portion of said pair of members by applying a second trigger energy for causing a chain-reacting curing reaction of the adhesive agent at a second specified point of the adhesive agent, thereby joining said different member to said pair of members,
wherein said second specified point of the adhesive agent where the second trigger energy is applied is configured such that a terminal portion of a first chain-reacting cure area of the adhesive agent which is presumed to be generated by applying said first trigger energy to the adhesive agent of the pair of members overlaps a start portion of a second chain-reacting cure area of the adhesive agent which is to be generated by applying said second trigger energy to the adhesive agent between the pair of members and the different member.

2. The adhesion assembly method of an article of claim 1, wherein said first chain-reacting cure area comprises plural areas which are disposed linearly on the joining portion of the member, and said first specified point of the adhesive agent where the first trigger energy is applied is located substantially at a central portion of the first chain-reacting cure area.

3. The adhesion assembly method of an article of claim 1, wherein said second specified point of the adhesive agent where the second trigger energy is applied is located substantially at said terminal portion at both ends of said first chain-reacting cure area.

4. The adhesion assembly method of an article of claim 1, wherein said applying the first or second trigger energy is applying a heat energy.

5. An adhesion assembly apparatus of an article, in which a plurality of members are joined with an adhesive agent having a chain-reacting curing reaction function that is disposed at joining portions of the members, thereby assembling the article, comprising:
a first trigger application means for applying a first trigger energy for causing a chain-reacting curing reaction of the adhesive agent, which is disposed at a joining portion of at least one of the members, at a first specified point of the adhesive agent in a state in which a joining portion of another member overlaps the joining portion of the member at which the adhesive agent is disposed, and
a second trigger application means for applying a second trigger energy for causing a chain-reacting curing reaction of the adhesive agent, which is disposed at a joining portion of a different member which is to be joined to said pair of members and/or a joining portion of said pair of members which is to be joined to the joining portion of the different member, at a second specified point of the adhesive agent,
wherein said second specified point of the adhesive agent where the second trigger energy is applied is configured such that a terminal portion of a first chain-reacting cure area of the adhesive agent which is presumed to be generated by applying said first trigger energy to the adhesive agent of the pair of members overlaps a start portion of a second chain-reacting cure area of the adhesive agent which is to be generated by applying said second trigger energy to the adhesive agent between the pair of members and the different member.

6. The adhesion assembly apparatus of an article of claim 5, wherein said first chain-reacting cure area comprises plural areas which are disposed linearly on the joining portion of the member, and said first specified point of the adhesive agent where the first trigger energy is applied by the first trigger application means is located substantially at a central portion of the first chain-reacting cure area.

7. The adhesion assembly apparatus of an article of claim 5, wherein said second specified point of the adhesive agent where the second trigger energy is applied by the second trigger application means is located substantially at said terminal portion at both ends of said first chain-reacting cure area.

8. The adhesion assembly apparatus of an article of claim 5, wherein said first and second trigger application means are configured to apply a heat energy as the trigger energy.
